(19) United States
(12) Patent Application Publication
(10) Pub. No.: US 2020/0140685 A1
(43) Pub. Date: May 7, 2020

(54) PROCESS FOR MAKING A FLEXIBLE POLYAMIDE POLYMER

(71) Applicant: VEERAG MEHTA, MONROE TOWNSHIP, NJ (US)

(72) Inventor: VEERAG MEHTA, MONROE TOWNSHIP, NJ (US)

(21) Appl. No.: 16/181,898

(22) Filed: Nov. 6, 2018

(51) Int. Cl. C08L 77/02

(52) U.S. Cl. CPC C08L 77/02; C08L 2205/03; C08L 2207/04; C08L 2203/30; C08L 2203/16

(57) ABSTRACT

A process for preparing a thermoplastic resin, the process comprising providing and mixing a polyamide resin, a silicone elastomer and a radical initiator, wherein the silicone elastomer comprises a polydiorganosiloxane gum having a plasticity of at least 10 and having on average at least 2 alkenyl groups per polymeric chain, and the radical initiator is present in the range of 0.01 to 5 weight percent based on the weight of the silicone elastomer, wherein the weight ratio of the silicone elastomer to polyamide is from 0.5:99 to 60:40. Thereafter, dynamically vulcanizing the mixture described just above at an elevated temperature to cure the silicone elastomer.

### BACKGROUND OF THE INVENTION

This invention relates to novel flexible polyamide resins made by reactive extrusion. Polyamide resins have excellent features and benefits depending on the chemistry of the polyamide. They can have very high melting points, excellent chemical resistance, and exceptional physical properties. Furthermore, these properties can be altered or modified by the use of fillers, lubricants, plasticizers, and impact modifiers so that a broader property profile can be attained by polyamides.

One limitation of polyamides is their limited flexibility both at room temperature and at low temperatures. Though it is common to use plasticizers for increasing ductility, plasticizers have limited thermal stability and have been known to migrate over time. The plasticizer option is viable in resins like polyamide 12 and polyamide 11 that process at lower temperatures, however as the carbon chain length is reduced, the melting and processing temperature increases. This makes the incorporation and retention of plasticizers more challenging as some plasticizers will tend to volatize out during compounding or processing due to the high processing temperature.

In addition to volatility during processing, plasticizers have a solubility that is based on environmental temperature. As a result, if a polyamide with plasticizers is stored at an elevated temperature, or exposed to an elevated temperature which is lower than the melting point, the level of plasticizer will be different from the same polyamide with plasticizer that is stored at a lower temperature, which will then change the ductility of the polyamide resin.

The use of polysiloxane in combination with polyamide has been done for many years. Polysiloxanes have been used for improving the surface properties of polyamide including properties like scratch and mar resistance and lowering of surface coefficient of friction. A new use of siloxane modified polyamides is detailed in U.S. Pat. No. 6,569,955B1 and U.S. Pat. No. 6,362,288B1 where the curing of a silicone rubber could be dynamically vulcanized into a polyamide to make a thermoplastic elastomer using silicon hydride addition to a double bond.

However the limitation on such products is that they still do not have ductility and flexibility, and processability similar to that of plasticized polyamide, or even copolymers of polyamide and polyether. Lastly, those materials, have limitations on processing using processes like injection molding.

### THE INVENTION

Thus, there is claimed and disclosed herein a process for preparing a thermoplastic resin, the process comprising providing and mixing a polyamide resin, a silicone elastomer and a radical initiator, wherein the silicone elastomer comprises a polydiorganosiloxane gum having a plasticity of at least 10 and having on average at least 2 alkenyl groups per polymeric chain, and the radical initiator is present in the range of 0.01 to 5 weight percent based on the weight of the silicone elastomer, wherein the weight ratio of the silicone elastomer to polyamide is from 0.5:99 to 60:40. Thereafter, dynamically vulcanizing the mixture described just above at an elevated temperature to cure the silicone elastomer.

In the process named just above, there is optionally present, an adhesion additive and a reinforcing agent in the range of 0.1 to 50 weight percent based on the weight of the polydiorganosiloxane gum.

### DETAILED DESCRIPTION OF THE INVENTION

The process according to the invention utilizes a twin screw compounder, or similar high shear mixer like a co-kneader or similar, to mix and react in one embodiment, a thermoplastic polyamide, a silicone elastomer, a radical initiator, and an adhesion additive. According to the process of this invention, the thermoplastic resin is prepared by thoroughly mixing the silicone elastomer in the thermoplastic polyamide and dynamically vulcanizing the silicone elastomer.

This process is conducted at an “elevated temperature” for purposes of this invention, which is at least the melt processing temperature of the polyamide. Preferably, the temperature is at least 10° C. above the melting temperature of the polyamide and at least 10° C. above a temperature that activates the radical initiator whichever temperature is higher.

For purposes of this invention, the weight ratio of silicone elastomer to the polyamide can range from 0.5:99.5 to 70:30. Preferably, the weight content of silicone elastomer in the polyamide resin is between 5 and 50 weight percent, more preferably between 10 and 40 weight percent, and most preferred between 15 and 30 weight percent wherein weight percent is with respect to the total weight of the thermoplastic resin.

The polyamide can be selected from any commercial polyamide resin including but not limited to PA6, PA66, PA666, PA46, PA610, PA612, PA11, PA12, PA1010, PA1012, just to name a few as well as copolymers of the stated polymers with polyether or polyethylene glycol.

The silicone elastomer comprises a polydiorganosiloxane gum having a plasticity of at least 10 and having an average of at least 2 alkenyl groups per molecule and optionally comprising a reinforcing agent at levels of 0.5 to 50 parts by weight with respect to the polydiorganosiloxane gum, wherein the weight ratio of said silicone elastomer to said polyamide is from 0.5:99.5 to 60:40. The polydiorganosiloxane gum has a plasticity of at least 10, which can be measured according to ASTM D926-08.

The polydiorganosiloxane gum is defined as ultra-high molecular weight polydiorganosiloxane having a molecular weight (Mn) of at least 10,000 g/mol and not more than about 1,000,000 g/mol (Mn). The organic groups of the polydiorganosiloxane are independently selected from hydrocarbon or halogenated hydrocarbon radicals such as alkyl and substituted alkyl radicals containing from 1 to 20 carbon atoms; alkenyl radicals, such as vinyl and 5-hexenyl; cycloalkyl radicals, such as cyclohexyl; and aromatic hydrocarbon radicals, such as phenyl benzyl and tolyl. Preferred organic groups are lower alkyl radicals containing from 1 to 4 carbon atoms, phenyl, and halogen-substituted alkyl such as 3,3,3-trifluoropropyl.

Thus, the polydiorganosiloxane can be a homopolymer, a copolymer or a terpolymer containing such organic groups. Examples include polydiorganosiloxanes comprising dimethylsiloxy units and phenylmethylsiloxy units; dimethylsiloxy units and diphenylsiloxy units: and dimethylsiloxy units. diphenylsiloxy units and phenylmethylsiloxy units, among others. Most preferably, the polydiorganosiloxane is a polydimethylsiloxane which is terminated with a vinyl group at each end of its molecule and/or contains at least one vinyl group along its main chain, thus as a pendant group.

The optional and preferred reinforcing agent (E) is silica filler. The silica filler that may be employed in this invention are finely divided fillers derived from fumed or precipitated forms, or from silica aerogels. These fillers are well known and are typically characterized by surface areas greater than about 50 m²/gram. The fumed form of silica is the preferred reinforcing agent based on its availability, cost, and high surface area, which can be as high as 900 m²/gram, but preferably has a surface area of 50 to 400 m²/gram.

These silicas are also very easy to manufacture and handle. It is contemplated within the scope of this invention to use a silicone elastomer that does not contain silica filler, or that contains very small amounts of silica filler. Thus, amounts of silica may range from zero parts per 100 parts of the silicone elastomer up to less than 1 part of silica filler in a silicone elastomer.

For purposes of this invention, the silica filler, if used, is preferably treated by reaction with a liquid organosilicon compound containing silanol groups or hydrolyzable precursors of silanol groups. Compounds that can be used as filler treating agents, also referred to as anti-creping agents, include such components as low molecular weight liquid hydroxy- or alkoxy-terminated polydiorganosiloxanes, hexaorganodisiloxanes and hexaorgano-disilazanes. The silicon-bonded hydrocarbon radicals in or on a portion of the filler treating agent can contain substituents such as carbon to carbon double bonds. It is preferred that the treating compound is an oligomeric hydroxy-terminated polydimethyl-siloxane having an average degree of polymerization (DP) of about 2 to about 100. A highly preferred treating fluid of this type has a DP of about 2 to 10.

The silica filler, if used in the present method, can be reacted with about 1 to about 45 weight percent, based on silica filler weight, of the filler treating agent prior to being blended with the polydiorganosiloxane to form the silicone elastomer. Treatment of the silica filler can be carried out in the same mixing vessel used to prepare the silicone rubber. The silica or other reinforcing filler is typically maintained at a temperature greater than about 100 degrees centigrade to about 200 degrees centigrade during the treatment process. Alternatively, the filler can be treated while it is being blended with the high consistency polydiorganosiloxane during preparation of the silicone elastomer.

The preparation of the silicone elastomer useful in this invention can be found in U.S. Pat. No. 5,508,323, among others, and the disclosure with regard to this preparation is hereby incorporated by reference for what it teaches about such silicone elastomer preparation.

The radical initiators useful in this invention are any compounds capable of providing free radicals for the subsequent vulcanization of the silicone elastomer. Such radical initiators can be exemplified and selected from the group consisting of (i) 2,2′-azobisisobutyronitrile, (ii) 2,2′-azobis(2-methylbutyronitrile), (iii) dibenzoyl peroxide, (iv) tert-amyl peroxyacetate, (v) 1,4-di(2-tert-butylperoxyisoproyl)benzene, monohydroperoxide, (vi) cumyl hydroperoxide, (vii) tert-butyl hydroperoxide, (viii) tert-amyl hydroperoxide, (ix) 1,1-d(tert-butylperoxy)cyclohexane, (x) tert-butylperoxy isopropyl carbonate, (xi) tert-amyl peroxybenzoate, (xii) dicumyl peroxide, (xiii) 2,5-dimethyl-2,5-di-(tert-butylperoxy)hexane, (xiv) bis(1-methyl-1-phenylethyl)peroxide, (xv) 2,5-dimethyl-2,5-di-(tert-butylperoxy)hexyne-3, (xvi) di-tert-butyl peroxide, (xvii) a,a-dimethylbenzyl hydroperoxide, (xviii) 3,4-dimethyl-3,4-diphenylhexane, (xix) t-butyl hydroperoxide, (xx) t-butyl peroxy 0-toluate, (xxi) cyclic peroxy ketal, (xxii) t-butyl peroxypivalate, (xxiii) lauroyl peroxide, (xxiv) t-amyl peroxy-2-ethylhexanoate, (xxv) vinyltris(t-butyl peroxy)silane, (xxvi) di-t-butylperoxide, (xxvii) 2,2,4-trimethylpentyl-2-hydroperoxide, (xxviii) 2,5-bis(t-butylperoxy)-2,5-dimethylhexyne-3, (xxix) t-butyl-peroxy-3,55-trimethylhexanoate, (xxx) cumene hydroperoxide, (xxxi) t-butyl peroxybenzoate, (xxxii) diisopropylbenzene mono hydroperoxide, and (xxxiii) combinations of (i) to (xxxii). The preferred radical initiator is selected based on the melting temperature of the polyamide. It is best to use an initiator based on a half-life greater than 20° C. above the Tm of the polyamide.

The radical initiator is used in an amount sufficient to cure the polydiorganosiloxane gum and this amount can be optimized for a given system by those skilled in the art using routine experimentation. When the amount is too low, insufficient crosslinking takes place and mechanical properties suffer accordingly. Optimum performance can be readily determined by a few simple experiments for the system under consideration. Moreover, information can be obtained from the manufacturer with regard to the performance (half-life) of the initiator.

The radical initiator is added in the amount of 0.01 to 5 weight percent based on the weight of the silicone elastomer. More preferred is an amount of 0.05 to 4 weight percent.

Also useful in this invention are adhesion additives (also known as coupling agents). Such additives and how they are used are well known in the art. For example, in U.S. Pat. No. 5,508,323 there is disclosed at column 6, beginning at line 16, a full disclosure of what these materials are and that information is incorporated herein by reference for what it teaches about such adhesion additives and how they are used.

Preferably, the adhesion additive comprises a polyolefin comprising an acrylate, maleic anhydride, and/or acid functionality. Preferred for this invention is the use of a level of adhesion additive of about 0.5 to about 30 weight percent with respect to the weight of said silicone elastomer, the addition being preferably carried out after the polydiorganosiloxane gum and treated silica filler have been mixed.

The polyamide may also be provided as a composition comprising the polyamide and further additives. The further additives may also be added during the process according to the invention and/or added to the thermoplastic resin as obtained with the process according to the invention in a subsequent compounding step.

Further additives are, for example, stabilizers, catalysts, nucleating agents, colorants, including but not limited to pentaerythritol tetrakis(3-(3,5-di-tert-butyl-4-hydroxyphenyl) propionate) (commercially available as Irganox 1010 from BASF), fillers, such as for example glass fibers and carbon fibers, as well as fire retardants.

Surprisingly, with the process according to the invention it is possible to have a polyamide resin with excellent flexibility and great chemical resistance to some inorganic chlorinated salts. As elaborated above, the polyamide resin as obtained by the process may be employed as such or in combination with further additives. The polyamide resin may be further processed in processes known per se, such as injection molding, blow molding, film extrusion, such as cast and blown film process, 3D printing processes such as fused deposition modeling, as well as other processes.

With the process according to the invention it is possible to provide a thermoplastic resin which can be employed in many applications such but not limited to automotive fuel line, hydraulic hoses, oil and gas umbilicals, cable ties, fasteners, conduits, belting, wearable technology, medical devices, and electrical wiring.

The advantages of employing the thermoplastic resin as obtained by the process of the invention in these applications are that modulus is much more tunable, and the resultant polyamide has superior chemical resistance which would not have been possible without the modification and composition explained in this invention.

### Example

Thermoplastic polyamide 6 having an RV of 3.3.
A polydiorganosiloxane gum having an Mn of 60,000 and having 300 ppm of a vinyl functionality with 3 weight percent of a precipitated silica having a surface area of 250 m²/g as reinforcing agent and the radical initiator 1 weight percent of a dicumyl peroxide, based on the weight of the silicone elastomer. The adhesion additive was a maleic anhydride functional polyethylene.

Thermoplastic resin with 20 weight percent of modification, wherein weight percent is with respect to the thermoplastic resin were prepared as follows:

80 weight percent of polyamide 6, 10 weight percent adhesion additive, and 10 weight percent silicone elastomer in which weight percent is with respect to the total weight of thermoplastic resin, were mixed and dynamically vulcanized using an extruder at a temperature of about 240° C.
60 weight percent of a polyamide, 20 weight percent adhesion additive, and 20 weight percent silicone elastomer, in which weight percent is with respect to the total weight of thermoplastic resin were mixed and dynamically vulcanized using an extruder at a temperature of about 240° C.
Rilsamid AESNO P40 TL: Commercially available (Arkema, Colombes, France), PA12

### Testing—

### Tensile Properties:

Tensile properties were measured according to the ASTM D638. Test temperature was 23° C. Samples were tested dry as molded (DAM) and conditioned for 24 hrs. at ambient conditions (23° C. and 50% rel. humidity).

TABLE 1

| | Tensile | Tensile | Tensile | Tensile |
|---|---|---|---|---|
| | Strength | Strength | Modulus | Modulus |
| Material | (DAM) | (Conditioned) | (DAM) | (Conditioned) |
| Rilsamid | 3825 psi | 3343 psi | 64872 psi | 52138 psi |
| AESNO | | | | |
| P40 TL | | | | |
| PA6 | 11989 psi | 6329 psi | 435132 psi | 145038 psi |
| PA6 with | 8529 psi | 5734 psi | 122239 psi | 109482 psi |
| 20% | | | | |
| Modifi- | | | | |
| cation | | | | |
| PA6 with | 5955 psi | 4987 psi | 75340 psi | 62160 psi |
| 40% | | | | |
| Modifi- | | | | |
| cation | | | | |

The results in Table 1 clearly show that with the modification with the free radical cured silicone elastomer and the use of an adhesion additive significantly reduce the stiffness of the PA6 to make it comparable to a PA12 plasticized polymer.

What is claimed is:

1. A process for preparing a thermoplastic resin, said process comprising:
A. providing and mixing a polyamide resin, a silicone elastomer and a radical initiator, wherein said silicone elastomer comprises a polydiorganosiloxane gum having a plasticity of at least 10 and having on average at least 2 alkenyl groups per polymeric chain, and said radical initiator being present in the range of 0.01 to 5 weight percent based on the weight of the silicone elastomer, wherein the weight ratio of the silicone elastomer to polyamide is from 0.5:99 to 60:40;
B. dynamically vulcanizing the mixture of A. at an elevated temperature to cure the silicone elastomer.

2. The process as claimed in claim 1 wherein, in addition, there is present, an adhesion additive.

3. The process as claimed in claim 1 wherein, in addition, there is present, a reinforcing agent in the range of 0.1 to 50 weight percent based on the weight of the polydiorganosiloxane gum.

4. The process as claimed in claim 1, wherein the content of silicone elastomer in the thermoplastic resin is in the range of 5 and 30 weight percent with respect to the total weight of the thermoplastic resin.

5. The process as claimed in claim 1 wherein the adhesion additive comprises a polyolefin selected from the group consisting of an acrylate, maleic anhydride, and/or acid functionality.

6. The process as claimed in claim 1, wherein the polydiorganosiloxane gum has a molecular weight (Mn) of at least 10,000 g/mol and not more than 1,000,000 g/mol.

7. The process as claimed in claim 1, wherein the Polydiorganosiloxane gum comprises organic groups being alkyl and substituted alkyl radicals, alkenyl radicals, cycloalkyl radicals, aromatic hydrocarbon radicals and combinations thereof.

8. The process as claimed in claim 1, wherein the polydiorganosiloxane gum is terminated with a vinyl group.

9. The process as claimed in claim 1, wherein the polydiorganosiloxane gum contains at least one vinyl group as a pendant group.

10. The process as claimed in claim 1 wherein the Polydiorganosiloxane gum contains at least one terminal vinyl group and at least one pendant vinyl group.

11. A polyamide resin prepared by the process of claim 1.

12. A thermoplastic comprising as a dispersed phase a silicone elastomer compound comprising a radically cross-linked polydiorganosiloxane and as continuous or co-continuous phase a polyamide compound comprising a polyamide wherein the weight ratio of the continuous phase to the dispersed phase is from 99.5:0.5 to 60:40, wherein the dispersed phase may comprise up to 50% by weight of a reinforcing filler.

13. A polyamide resin as claimed in claim 11 wherein said polyamide is an elastomer.

14. The polyamide resin as claimed in claim 11 wherein said polyamide resin has increased chemical resistance to chlorinated salts and aqueous versions of chlorinated salts.

15. The polyamide resin as claimed in claim 11 when fabricated into
i. tubing,
ii. injection molded articles,
iii. films,
iv. 3D printed items,
v. wearable devices,
vi. extruded articles, and,
vii. thermoformed articles.
